(19) United States
(12) Patent Application Publication
(10) Pub. No.: US 2016/0225060 A1
(43) Pub. Date: Aug. 4, 2016

(54) RESEARCH SYSTEM AND METHOD

(71) Applicant: Michael R. Gants, Lexington, MA (US)

(72) Inventor: Michael R. Gants, Lexington, MA (US)

(21) Appl. No.: 15/011,069

(22) Filed: Jan. 29, 2016

Related U.S. Application Data
(60) Provisional application No. 62/109,242, filed on Jan. 29, 2015.

(51) Int. Cl. G06Q 30/06; G06Q 50/18

(52) U.S. Cl. CPC G06Q 30/0629; G06Q 50/18

(57) ABSTRACT

A method, computer program product, and computing system for receiving search criteria concerning a potential legal services engagement for a user. The search criteria are compared to one or more lawyer profiles to generate a result set, wherein each lawyer profile included within the result set includes a plurality of discrete experience indicators. The plurality of discrete experience indicators included within each lawyer profile within the result set are ordered based, at least in part, upon the search criteria, thus generating a dynamic result set.

### RELATED APPLICATION

This application claims the benefit of U.S. Provisional Application No. 62/109,242 filed on 29 Jan. 2015, entitled “System and Method For Comparing Legal Service Providers”, the contents of which are incorporated herein by reference.

### TECHNICAL FIELD

This disclosure relates to network-based research systems and, more particularly, to network-based research systems concerning the legal industry.

### BACKGROUND

The legal industry is one of those specialized practice areas in which the general consuming public has little knowledge concerning the manner in which the industry actually works. Accordingly, such consuming public often has to blindly rely on the proclamations of service providers within the industry. Unfortunately, this results in a system that is difficult for consumers of these legal services to research or to perform any type of meaningful comparison of legal services providers practicing within the industry.

### SUMMARY OF DISCLOSURE

In one implementation, a computer-implemented method is executed on a computing device and includes receiving search criteria concerning a potential legal services engagement for a user. The search criteria are compared to one or more lawyer profiles to generate a result set, wherein each lawyer profile included within the result set includes a plurality of discrete experience indicators. The plurality of discrete experience indicators included within each lawyer profile within the result set are ordered based, at least in part, upon the search criteria, thus generating a dynamic result set.

One or more of the following features may be included. The dynamic result set may be provided to the user. The search criteria may identify a particular area of the law. Comparing the search criteria to one or more lawyer profiles to generate a result set may include comparing the specific area of the law to the plurality of discrete experience indicators included within each lawyer profile within the result set to identify at least one more relevant discrete experience indicator. Ordering the plurality of discrete experience indicators included within each lawyer profile within the result set may include promoting the at least one more relevant discrete experience indicator when ordering the plurality of discrete experience indicators included within each lawyer profile within the result set. Comparing the search criteria to one or more lawyer profiles to generate a result set may include comparing the specific area of the law to the plurality of discrete experience indicators included within each lawyer profile within the result set to identify at least one less relevant discrete experience indicator. Ordering the plurality of discrete experience indicators included within each lawyer profile within the result set may include demoting the at least one less relevant discrete experience indicator when ordering the plurality of discrete experience indicators included within each lawyer profile within the result set.

In another implementation, a computer program product resides on a computer readable medium and has a plurality of instructions stored on it. When executed by a processor, the instructions cause the processor to perform operations including receiving search criteria concerning a potential legal services engagement for a user. The search criteria are compared to one or more lawyer profiles to generate a result set, wherein each lawyer profile included within the result set includes a plurality of discrete experience indicators. The plurality of discrete experience indicators included within each lawyer profile within the result set are ordered based, at least in part, upon the search criteria, thus generating a dynamic result set.

One or more of the following features may be included. The dynamic result set may be provided to the user. The search criteria may identify a particular area of the law. Comparing the search criteria to one or more lawyer profiles to generate a result set may include comparing the specific area of the law to the plurality of discrete experience indicators included within each lawyer profile within the result set to identify at least one more relevant discrete experience indicator. Ordering the plurality of discrete experience indicators included within each lawyer profile within the result set may include promoting the at least one more relevant discrete experience indicator when ordering the plurality of discrete experience indicators included within each lawyer profile within the result set. Comparing the search criteria to one or more lawyer profiles to generate a result set may include comparing the specific area of the law to the plurality of discrete experience indicators included within each lawyer profile within the result set to identify at least one less relevant discrete experience indicator. Ordering the plurality of discrete experience indicators included within each lawyer profile within the result set may include demoting the at least one less relevant discrete experience indicator when ordering the plurality of discrete experience indicators included within each lawyer profile within the result set.

In another implementation, a computing system including a processor and memory is configured to perform operations including receiving search criteria concerning a potential legal services engagement for a user. The search criteria are compared to one or more lawyer profiles to generate a result set, wherein each lawyer profile included within the result set includes a plurality of discrete experience indicators. The plurality of discrete experience indicators included within each lawyer profile within the result set are ordered based, at least in part, upon the search criteria, thus generating a dynamic result set.

One or more of the following features may be included. The dynamic result set may be provided to the user. The search criteria may identify a particular area of the law. Comparing the search criteria to one or more lawyer profiles to generate a result set may include comparing the specific area of the law to the plurality of discrete experience indicators included within each lawyer profile within the result set to identify at least one more relevant discrete experience indicator. Ordering the plurality of discrete experience indicators included within each lawyer profile within the result set may include promoting the at least one more relevant discrete experience indicator when ordering the plurality of discrete experience indicators included within each lawyer profile within the result set. Comparing the search criteria to one or more lawyer profiles to generate a result set may include comparing the specific area of the law to the plurality of discrete experience indicators included within each lawyer profile within the result set to identify at least one less relevant discrete experience indicator. Ordering the plurality of discrete experience indicators included within each lawyer profile within the result set may include demoting the at least one less relevant discrete experience indicator when ordering the plurality of discrete experience indicators included within each lawyer profile within the result set.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a legal research process according to an implementation of the present disclosure;

FIG. 2 is a flowchart of a first implementation of the legal research process of FIG. 1 according to an implementation of the present disclosure;

FIG. 3 is a flowchart of a second implementation of the legal research process of FIG. 1 according to an implementation of the present disclosure;

FIG. 4 is a flowchart of a third implementation of the legal research process of FIG. 1 according to an implementation of the present disclosure;

FIG. 5 is a flowchart of a fourth implementation of the legal research process of FIG. 1 according to an implementation of the present disclosure;

FIG. 6 is a flowchart of a fifth implementation of the legal research process of FIG. 1 according to an implementation of the present disclosure;

FIG. 7 is a flowchart of a sixth implementation of the legal research process of FIG. 1 according to an implementation of the present disclosure; and

Like reference symbols in the various drawings indicate like elements.

### DETAILED DESCRIPTION OF THE PREFERRED EMBODIMENTS

### System Overview

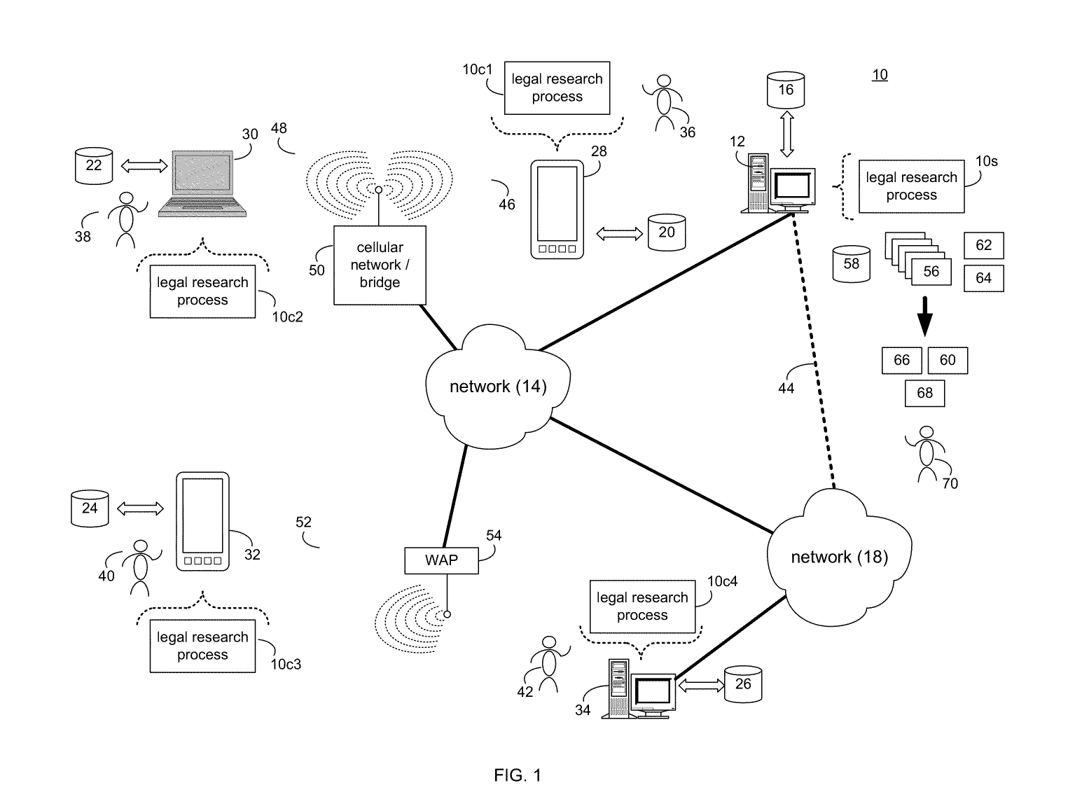

Referring to FIG. 1, there is shown legal research process 10. As will be discussed below in greater detail, legal research process 10 may be utilized to allow users to navigate the legal system and research legal issues and legal service providers.

Legal research process 10 may be implemented as a server-side process, a client-side process, or a hybrid server-side/client-side process. For example, legal research process 10 may be implemented as a purely server-side process via legal research process 10s. Alternatively, legal research process 10 may be implemented as a purely client-side process via one or more of legal research process 10c1, legal research process 10c2, legal research process 10c3, and legal research process 10c4. Alternatively still, legal research process 10 may be implemented as a hybrid server-side/client-side process via legal research process 10s in combination with one or more of legal research process 10c1, legal research process 10c2, legal research process 10c3, and legal research process 10c4. Accordingly, legal research process 10 as used in this disclosure may include any combination of legal research process 10s, legal research process 10c1, legal research process 10c2, legal research process 10c3, and legal research process 10c4.

Legal research process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of legal research process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of legal research processes 10c1, 10c2, 10c3, 10c4 may include but are not limited to a web browser, a game console user interface, or a specialized application (e.g., an application running on e.g., the Android™ platform or the iPhone™ platform). The instruction sets and subroutines of legal research applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access legal research process 10 directly through network 14 or through secondary network 18. Further, legal research process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Legal Research Process:

As discussed above, legal research process 10 may be utilized to allow users to navigate the legal system and research legal issues and legal service providers. For example, legal research process 10 may provide users with various services, such as:
Automated Qualification & Selection: As will be discussed below in greater detail and in response to an initial inquiry, legal research process 10 may be configured to dynamically generate a series of questions that are based, at least in part, upon one or more answers provided to earlier asked questions. These answers may be analyzed to identify a legal task to be performed within a particular area of law. Once this legal task is identified, an attorney database may be searched to identify one or more attorneys that are skilled in the particular area of law and are qualified to perform the identified legal task. The user of legal research process 10 may then be provided with a list of qualified attorneys.
Automated Knowledgebase: As will be discussed below in greater detail, legal research process 10 may be configured to ask a plurality of questions to identify the specific type of legal question that the user has and may then quantify that legal question in a manner that frames the issue for any lawyer being recommended by legal research process 10. For example and through a plurality of questions, legal research process 10 may determine that a user (e.g., the potential client) invented a piece of software that was beta tested from fifteen months ago until nine months ago, wherein this software has not yet been offered for sale to the general public. However, the high-level concepts of the software were disclosed on the user's website three months ago. The user is now interested in U.S. and international patent protection. Legal research process 10 may summarize these finding, wherein this summary may be provided to any lawyer(s) being recommended by legal research process 10.
Dynamic Information: As will be discussed below in greater detail and in response to an initial inquiry, legal research process 10 may be configured to dynamically generate a series of questions that are based, at least in part, upon one or more answers provided to earlier asked questions. These answers may be analyzed to identify information that is pertinent to the legal issue being inquired into by the user. The user of legal research process 10 may then be incrementally provided with this pertinent information as these questions are asked and answered.
Dynamic Profiles: As will be discussed below in greater detail, legal research process 10 may be configured to provide lawyer profiles in a fashion that is tailored to the search being performed by a user. For example, it is possible that a lawyer may be competent/qualified in many different areas. Specifically, an intellectual property attorney may be qualified in many things, such as IP due diligence, patents, trademarks and copyright. However, if a user is searching for a copyright attorney, they may need to waste time wading through the IP due diligence qualifications, patent qualifications and trademark qualifications before getting to what they inquired about (namely copyright qualifications). Accordingly, legal research process 10 may dynamically reorganize/reorder the individual qualifications/experiences included within any law profiles within a result set based upon the particular qualifications/experience defined by the user within their search.
Comparative Pricing for Defined Tasks: As will be discussed below in greater detail, legal research process 10 may be configured to allow an “apples-to-apples” cost comparison of two identical legal tasks (as opposed to simply comparing attorney billing rates), which often does not provide an indicator of the level of value provided by a particular lawyer. For example, if Lawyer A has a billing rate that is double that of Lawyer B, but Lawyer A (due to experience) produces work product three times more quickly than Lawyer B, Lawyer A (with the higher billing rate) would actually provide a higher level of value than Lawyer B (with the lower billing rate). Accordingly, legal research process 10 may provide lawyers identified within their system with one or more particular legal scenarios in their area(s) of expertise and may ask these lawyers to provide a price estimate for those procedures (thus factoring out the billing rate). Accordingly and continuing with the example provided above, the user may see that Lawyer A (who has a higher billing rate) can perform a certain service for the user for e.g., $5,000 while Lawyer B would charge the same user $7,500 for performing the same service (despite having a lower billing rate).
Bidirectional Review Verification: As will be discussed below in greater detail, legal research process 10 may be configured to avoid fraudulent online reviews of an attorney. Specifically and when submitting a review of an attorney, legal research process 10 may require a user to submit an email address and legal research process 10 may inquire as to whether the attorney recognizes the email address (without disclosing the content of the review). If the lawyer confirms the email address, legal research process 10 may post the review. If the lawyer does not recognize the email address, legal research process 10 may ask the user their full name and may present this name to the lawyer. If the lawyer confirms the name, legal research process 10 may post the review. If the lawyer does not recognize the name, legal research process 10 may post the review stating that the review is unverified (thus reducing the possibility of fraudulent/uncontrolled reviews).

### Automated Qualification & Selection:

For the following example, assume that user 38 is having financial difficulties and is considering filing for bankruptcy but does not know anything about the legal requirements for filing bankruptcy (and does not know any lawyers or legal professionals that practice in that area of the law). Accordingly, user 38 may access legal research process 10 via a website (e.g., www.justiserv.com) that allows user 38 to access the functionality of legal research process 10 via laptop computer 30. Further, assume that user 38 visits the website of legal research process 10 and selects “Bankruptcy” as the area of the law that they are interested in researching.

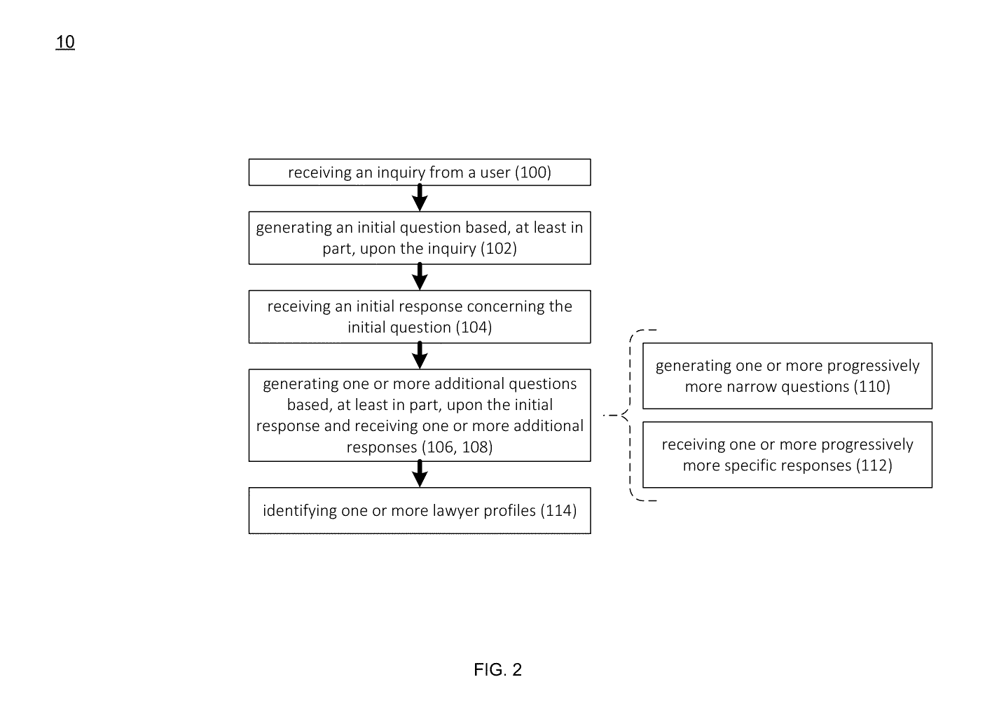

Referring also to FIG. 2 and concerning the Automated Qualification & Selection described above, legal research process 10 may be configured to receive 100 an inquiry from a user concerning a potential legal services engagement. This inquiry may be a passive inquiry (e.g., user 38 visiting a webpage) or an active inquiry (e.g., user 38 inquiring about legal services and/or professionals). In this particular example, the inquiry is more of an active inquiry, wherein user 38 proactively visited the website of legal research process 10 and selected “Bankruptcy” as the area of the law that they are interested in.

Legal research process 10 may be configured to generate 102 an initial question based, at least in part, upon the inquiry (e.g., selecting “Bankruptcy” as the area of law that they are interested in learning about). An example of the initial question generated 102 by legal research process 10 may include but is not limited to “Do you have more than five people living in your household (including yourself)?”

Legal research process 10 may be configured to receive 104 an initial response concerning the initial question. For example, assume the legal research process 10 receives 104 the response of “no” from user 38.

Legal research process 10 may be configured to generate 106 one or more additional questions based, at least in part, upon the initial response and receive 108 one or more additional responses concerning the one or more additional questions until a specific task within a particular area of law is associated with the potential legal services engagement.

Continuing with the above-stated example in which legal research process 10 received 104 an answer of “no” from user 38 concerning whether there are more than five people living in the household, legal research process 10 may generate 106 the additional question of “What is the actual size of the household?”. Since user 38 stated that there are five or less people living in their household, legal research process 10 may only accept an answer that is five or less or (alternatively) legal research process 10 may predefine answers that are selectable by user 38, wherein the predefined and selectable answers are all five or less.

Upon receiving 108 an answer to the question of “What is the actual size of the household?”, legal research process 10 may generate 106 additional questions (if needed) and receive 108 additional answers (if needed); and this process may be repeated until a specific task within a particular area of law is associated with the potential legal services engagement.

Assume for illustrative purposes that legal research process 10 is trying to determine whether user 38 is capable of filing a Chapter 7 bankruptcy or needs to file a Chapter 13 bankruptcy. For example, assume that user answered “four” in response to the question “What is the actual size of the household?” Being that filing Chapter 7 versus Chapter 13 bankruptcy filings are dependent upon annual income, legal research process 10 may generate 106 one or more additional questions to determine family income. For example, assume that legal research process 10 generates 106 an additional question concerning whether the household income of user 38 is above or below the cutoff for Chapter 7 bankruptcy.

In this case and for a family of four, the income cutoff for a Chapter 7 bankruptcy filing is $106,841. Accordingly, legal research process 10 may generate 106 the question of “Is your family income greater than $106,481?” In this example and for this question, legal research process 10 may be configured to allow user 38 to select from two choices (e.g., yes or no). Assume for this answer that user 38 earns $150,000 per year. Accordingly, user 38 may select the “yes” button and legal research process 10 may receive 108 this answer, which will disqualify user 38 from filing a Chapter 7 bankruptcy and will require that user 38 file a Chapter 13 bankruptcy. Accordingly and at this point in the process, legal research process 10 knows whether the bankruptcy of user 38 is Chapter 7 or Chapter 13 and legal research process 10 may adjust future questions accordingly.

As shown above, when generating 106 one or more additional questions based, at least in part, upon the initial response and receiving 108 one or more additional responses concerning the one or more additional questions, legal research process 10 may generate 110 one or more progressively more narrow questions based, at least in part, upon the initial response and may receive 112 one or more progressively more specific responses concerning the one or more progressively more narrow questions.

For example, when legal research process 10 received 108 an answer from user 38 that four people lived in their household, legal research process 10 generated 110 a narrower question (“What is the actual size of the household?”) that only accepts the answers of e.g., one, two, three, four or five. Further, legal research process 10 received 112 a narrower answer (“four”).

Once a specific task within a particular area of law is associated with the potential legal services engagement, legal research process 10 may be configured to identify 114 one or more lawyer profiles that each include experience concerning the specific task within the particular area of law. Continuing with the above-stated example in which the potential legal services engagement is a potential bankruptcy filing, assume that the specific task within the particular area of law is the filing of a Chapter 7 bankruptcy petition or the filing of a Chapter 13 bankruptcy petition. As discussed above, legal research process 10 has determined that a Chapter 7 bankruptcy filing is not an option for user 38 (they exceed the income cutoff) but a Chapter 13 bankruptcy filing is an available option for user 38.

Accordingly, legal research process 10 may be configured to identify 114 one or more lawyer profiles that each include experience concerning the filing of Chapter 13 bankruptcy petitions. For example and when identifying 114 the lawyer profiles, legal research process 10 may compare the specific legal task (e.g., the filing of a Chapter 13 bankruptcy petition) to a plurality of lawyer profiles (e.g., lawyer profiles 56) included within a legal database (e.g., database 58) to identify lawyer profiles that are qualified (i.e., include relevant experience). Legal research process 10 may then provide user 38 with a list of qualified lawyer profiles (e.g., in the form of result set 60) that provide the services that user 38 is interested in obtaining (e.g., the filing of a Chapter 13 bankruptcy petition).

### Automated Knowledgebase:

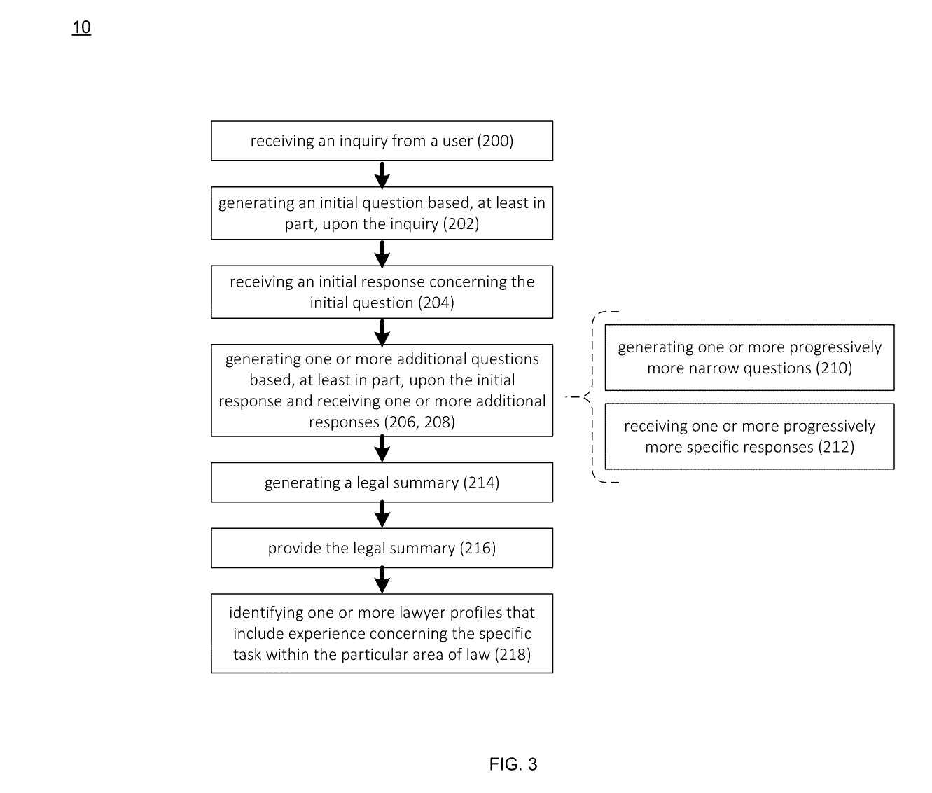

Referring also to FIG. 3 and continuing with the above-stated example in which user 38 is having financial difficulties and is considering filing for bankruptcy but does not know anything about the legal requirements for filing bankruptcy, legal research process 10 may be configured to prepare a legal summary for user 38 that identifies the specific task (e.g., Chapter 13 petitions) within the particular area of law (e.g., Bankruptcy) and quantifies specific legal criteria (e.g., number of people in the family and the family income level), wherein this legal summary may be provided to one or more of the lawyers identified within result set 60, thus eliminating the need of user 38 to reach out to one or more lawyers and reiterate the information that was already provided to legal research process 10.

Accordingly and concerning the Automated Knowledgebase described above, legal research process 10 may be configured to receive 200 an inquiry from a user concerning a potential legal services engagement. Again, this inquiry may be a passive inquiry (e.g., user 38 visiting a webpage) or an active inquiry (e.g., user 38 inquiring about legal services and/or professionals). Accordingly and in this particular example, this inquiry is more of an active inquiry, since user 38 proactively visited the website of legal research process 10 and selected “Bankruptcy” as the area of the law that they are interested in.

Again and following the example described above, legal research process 10 may be configured to generate 202 an initial question based, at least in part, upon the inquiry and may be configured to receive 204 an initial response concerning the initial question.

As in the above example, legal research process 10 may be configured to generate 206 one or more additional questions based, at least in part, upon the initial response and receive 208 one or more additional responses concerning the one or more additional questions until a specific task within a particular area of law is associated with the potential legal services engagement.

Again and as in the example above, when generating 206 the additional questions based upon the initial response and receiving 208 one or more additional responses concerning the one or more additional questions, legal research process 10 may generate 210 one or more progressively more narrow questions based upon the initial response and may receive 212 one or more progressively more specific responses concerning the one or more progressively more narrow questions.

Accordingly and continuing with the above-stated example in which user 38 selects “Bankruptcy” as the area of law that they are interested in learning about, legal research process 10 may generate 202 an initial question of “Do you have more than five people living in your household (including yourself)?” Legal research process 10 may be configured to receive 204 an initial response concerning the initial question, such as the response of “no” from user 38.

Legal research process 10 may generate 206 additional questions and may receive 208 additional responses concerning the additional questions until a specific task within a particular area of law is associated with the potential legal services engagement.

As above, this process may continue and be repeated until a specific task within a particular area of law is associated with the potential legal services engagement. Accordingly and upon receiving 204 an answer of “no” from user 38 concerning whether there are more than five people living in the household, legal research process 10 may generate 206 the additional question of “What is the actual size of the household?” and may receive 208 the responses of “four” from user 38.

As stated above, assume that legal research process 10 is trying to determine whether user 38 is capable of filing a Chapter 7 bankruptcy or needs to file a Chapter 13 bankruptcy (which depends upon family income), legal research process 10 may generate 206 additional questions to determine family income. Accordingly, legal research process 10 may generate 206 the question of “Is your family income greater than $106,481?”, which is the cutoff for filing a Chapter 7 bankruptcy petition for a family of four. As discussed above, since user 38 earns $150,000 per year, user 38 may answer that they earn more than $106,481 and therefore will be unable to file a Chapter 7 bankruptcy petition.

Again and as discussed above, when generating 206 the additional questions and receiving 208 the additional responses, legal research process 10 may generate 210 one or more progressively more narrow questions (based upon the initial response) and may receive 212 one or more progressively more specific responses (based upon the one or more progressively more narrow questions). For example, when legal research process 10 received 208 an answer from user 38 that four people lived in their household, legal research process 10 generated 210 a narrower question (“Is your family income greater than $106,481?”) that only accepts the answers of e.g., Yes or No, to which legal research process 10 received 212 a narrower answer (“Yes”).

Continuing with the above-stated example, once a specific task (e.g., the filing of a Chapter 13 petition) within a particular area of law (e.g., Bankruptcy) is associated with the potential legal services engagement, legal research process 10 may be configured to generate 214 a legal summary (e.g., legal summary XXX) that identifies the specific task (e.g., the filing of a Chapter 13 petition) within a particular area of law (e.g., Bankruptcy) and quantifies specific legal criteria concerning the specific task (e.g., namely that it is a family of four that makes over $106,481 per year). Legal research process 10 may be configured to provide 216 the legal summary to one or more lawyers for review.

Accordingly, legal research process 10 may be configured to identify 218 one or more lawyer profiles that each include experience concerning the filing of Chapter 13 bankruptcy petitions. For example and when identifying 218 the lawyer profiles, legal research process 10 may compare the specific legal task (e.g., the filing of a Chapter 13 bankruptcy petition) to a plurality of lawyer profiles (e.g., lawyer profiles 56) included within a legal database (e.g., database 58) to identify lawyer profiles that are qualified (i.e., include relevant experience). Legal research process 10 may then provide user 38 with a list of qualified lawyer profiles (e.g., result set 60) that provide the services that user 38 is interested in obtaining.

### Dynamic Information:

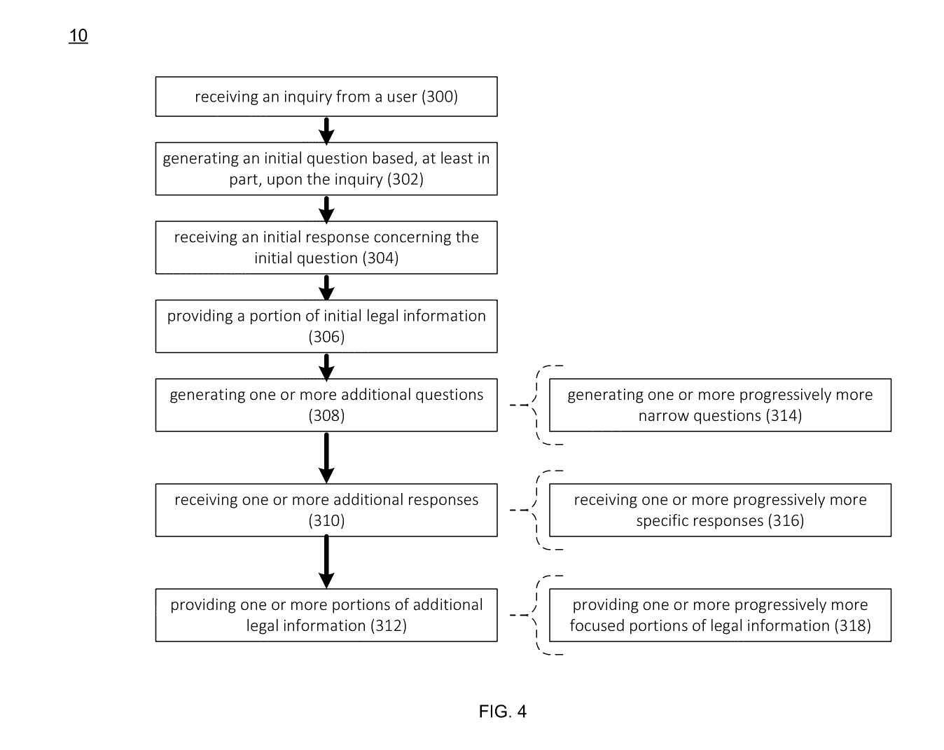

Referring also to FIG. 4 and continuing with the above-stated example in which user 38 is having financial difficulties and is considering filing for bankruptcy but does not know anything about the legal requirements for filing bankruptcy, legal research process 10 may be configured to provide user 38 with legal information concerning the particular area of law (e.g., Bankruptcy) being research, wherein the information provide may be dynamic in nature and may be refined as the user (e.g., user 38) is asked additional questions and provides additional answers.

Concerning the Dynamic Information described above, legal research process 10 may be configured to receive 300 an inquiry from a user concerning an area of law. Again, this inquiry may be a passive inquiry (e.g., user 38 visiting a webpage) or an active inquiry (e.g., user 38 inquiring about legal services and/or professionals). Accordingly and in this particular example, this inquiry is more of an active inquiry, since user 38 proactively visited the website of legal research process 10 and selected “Bankruptcy” as the area of the law that they are interested in.

Again and following the example described above, legal research process 10 may be configured to generate 302 an initial question based, at least in part, upon the inquiry and may be configured to receive 304 an initial response concerning the initial question. Additionally and for this particular implementation, legal research process 10 may be configured to provide 306 a portion of initial legal information concerning the area of law based, at least in part, upon the initial response.

As in the above example, legal research process 10 may be configured to generate 308 one or more additional questions based, at least in part, upon the initial response and receive 310 one or more additional responses concerning the one or more additional questions until a specific task within a particular area of law is associated with the potential legal services engagement. Further, legal research process 10 may be configured to provide 312 one or more portions of additional legal information concerning the area of law based, at least in part, upon the one or more additional responses.

Again and as in the example above, when generating 308 the additional questions based upon the initial response and receiving 310 one or more additional responses concerning the one or more additional questions, legal research process 10 may generate 314 one or more progressively more narrow questions based upon the initial response and may receive 316 one or more progressively more specific responses concerning the one or more progressively more narrow questions. Further, when providing 312 one or more portions of additional legal information concerning the area of law based, at least in part, upon the one or more additional responses, legal research process 10 may provide 318 one or more progressively more focused portions of legal information concerning the area of law based, at least in part, upon the one or more progressively more specific responses.

Accordingly and continuing with the above-stated example in which user 38 selects “Bankruptcy” as the area of law that they are interested in learning about, legal research process 10 may generate 302 an initial question of “Do you have more than five people living in your household (including yourself)?” Legal research process 10 may be configured to receive 304 an initial response concerning the initial question, such as the response of “no” from user 38. Since in this particular example, the area of the law that user 38 is interested in is “Bankruptcy”, legal research process 10 may be configured to provide 306 initial legal information (e.g., information 62) concerning bankruptcy. Information 62 provided may be high level information that generally described what protections the filing of a bankruptcy petition may provide to (in this example) user 38.

Legal research process 10 may generate 308 additional questions, may receive 310 additional responses concerning the additional questions until a specific task within a particular area of law is associated with the potential legal services engagement, and may provide 312 one or more portions of additional legal information concerning the area of law based, at least in part, upon the one or more additional responses.

As above, this process may continue and be repeated until a specific task within a particular area of law is associated with the potential legal services engagement. Accordingly and upon receiving 304 an answer of “no” from user 38 concerning whether there are more than five people living in the household, legal research process 10 may generate 308 the additional question of “What is the actual size of the household?”, may receive 310 the responses of “four” from user 38, and may provide 312 additional legal information 64 concerning why they are asking (e.g., possibly explaining any cutoffs concerning maximum or minimum allowable family members).

As stated above, assume that legal research process 10 is trying to determine whether user 38 is capable of filing a Chapter 7 bankruptcy or needs to file a Chapter 13 bankruptcy (which depends upon family income), legal research process 10 may generate 308 additional questions to determine family income. Accordingly, legal research process 10 may generate 308 the question of “Is your family income greater than $106,481?”, which is the cutoff for filing a Chapter 7 bankruptcy petition for a family of four. As discussed above, since user 38 earns $150,000 per year, legal research process 10 may receive 310 an answer from user 38 that they earn more than $106,481 and therefore will be unable to file a Chapter 7 bankruptcy petition. Legal research process 10 may also provide 312 additional legal information 64 concerning why they are asking (e.g., possibly explaining the income cutoff that is associated with filing a Chapter 7 bankruptcy petition).

Again and as discussed above, when generating 308 the additional questions and receiving 310 the additional responses, legal research process 10 may generate 314 one or more progressively more narrow questions (based upon the initial response) and may receive 316 one or more progressively more specific responses (based upon the one or more progressively more narrow questions). For example, when legal research process 10 received 310 an answer from user 38 that four people lived in their household, legal research process 10 generated 314 a narrower question (“Is your family income greater than $106,481?”) that only accepts the answers of e.g., Yes or No, to which legal research process 10 received 316 a narrower answer (“Yes”).

When providing 312 one or more portions of additional legal information concerning the area of law based, at least in part, upon the one or more additional responses, legal research process 10 may provide 318 one or more progressively more focused portions of legal information concerning the area of law based, at least in part, upon the one or more progressively more specific responses. For example, when legal research process 10 received 316 a narrower answer (“Yes”) to the question “Is your family income greater than $106,481?”, legal research process 10 may provide 318 more focused legal information that explains that user 38 has exceeded the income cutoff for a Chapter 7 bankruptcy filing.

### Dynamic Profiles:

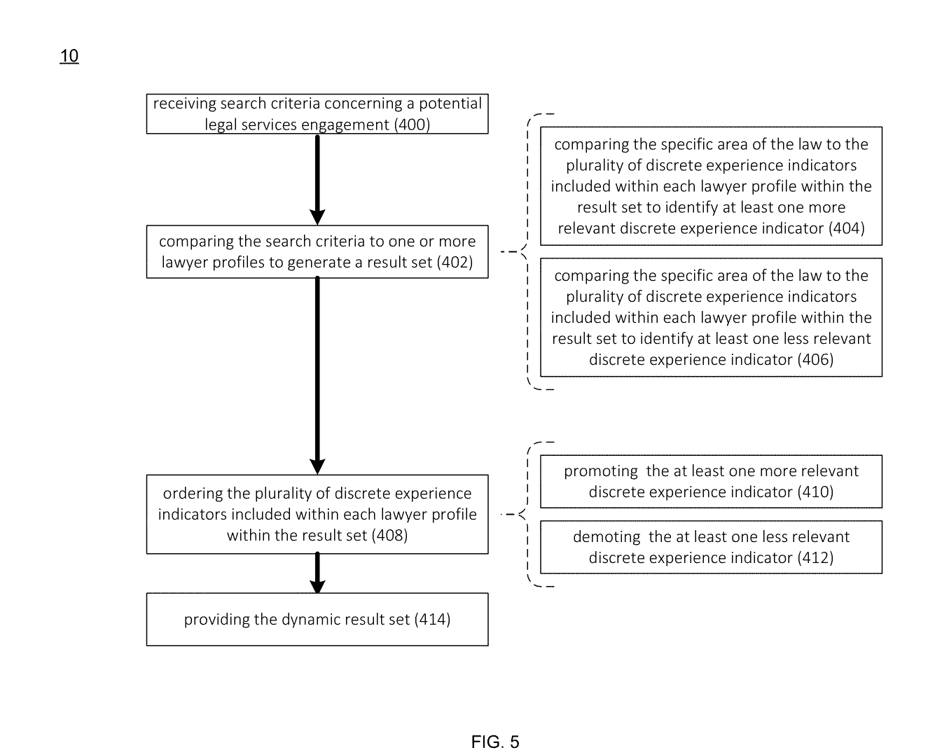

Referring also to FIG. 5 and continuing with the above-stated example in which user 38 is having financial difficulties and is considering filing for bankruptcy but does not know anything about the legal requirements for filing bankruptcy, legal research process 10 may be configured to allow user 38 to research attorneys that practice with this particular area of law.

As discussed above, legal research process 10 may maintain a plurality of lawyer profiles (e.g., lawyer profiles 56) within a legal database (e.g., database 58), wherein each of these lawyer profiles 56 may list a plurality of discrete experience descriptors. Examples of such discrete experience descriptors may include but are not limited to specific areas of the law in which the attorney has experience, bars that they are admitted to, courts that they are admitted to, cases they have won, pro bono activities they participate in, board/organizations that they belong to, etc. Legal research process 10 may be configured to reorder these discrete experience descriptors identified within the lawyer profiles include within result set 60 to more prominently feature those discrete experiences descriptors that match the specific task (e.g., the filing of a Chapter 13 petition) within a particular area of law (e.g., Bankruptcy).

Concerning the Dynamic Profiles described above, legal research process 10 may be configured to receive 400 search criteria concerning a potential legal services engagement for a user, wherein this search criteria may identify a particular area of the law. Assume for the following discussion that user 38 is utilizing legal research process 10 to research bankruptcy law and (as discussed above) has responded to a plurality of questions. Further, assume that legal research process 10 has identified the specific task (e.g., the filing of a Chapter 13 petition) within the particular area of law (e.g., Bankruptcy) that user 38 may need assistance with.

Accordingly, legal research process 10 may receive 400 this information (i.e., the task of filing a Chapter 13 bankruptcy petition) and use it as search criteria concerning a potential legal services engagement for user 38.

When processing this search criteria (i.e., the filing a Chapter 13 bankruptcy petition), legal research process 10 may be configured to compare 402 the search criteria to lawyer profiles 56 included within legal database 58 to generate a result set (e.g., result set 60), wherein each lawyer profile included within result set 60 includes a plurality of discrete experience indicators.

As discussed above, the search criteria may identify a particular area of the law, wherein (in this example) that particular area of the law is bankruptcy law. Accordingly and when comparing 402 the search criteria (i.e., the filing a Chapter 13 bankruptcy petition) to one or more lawyer profiles (e.g., lawyer profiles 56 included within legal database 58) to generate a result set (e.g., result set 60), legal research process 10 may compare 404 the specific area of the law (i.e., bankruptcy law) to the plurality of discrete experience indicators included within each lawyer profile within result set 60 to identify at least one more relevant discrete experience indicator.

Conversely, when comparing 402 the search criteria (i.e., the filing a Chapter 13 bankruptcy petition) to one or more lawyer profiles (e.g., lawyer profiles 56 included within legal database 58) to generate a result set (e.g., result set 60), legal research process 10 may compare 406 the specific area of the law to the plurality of discrete experience indicators included within each lawyer profile within result set 60 to identify at least one less relevant discrete experience indicator.

As discussed above, examples of such discrete experience descriptors may include but are not limited to the specific areas of the law in which the attorney has experience. Accordingly, assume that all of the attorneys are bankruptcy attorneys and all include experience in Chapter 13 petitions (i.e., the service required by user 38). Further assume that some of the attorneys also have Chapter 7 bankruptcy petition experience . . . and some also have corporate legal experience . . . and some also have real estate experience . . . etc.

Legal research process 10 may be configured to order 408 the plurality of discrete experience indicators included within each lawyer profile (e.g., lawyer profiles 56 included within legal database 58) within result set 60 based, at least in part, upon the search criteria (i.e., the filing a Chapter 13 bankruptcy petition), thus generating dynamic result set 66.

As discussed above, legal research process 10 may compare 404 the specific area of the law (i.e., bankruptcy law) to the plurality of discrete experience indicators included within each lawyer profile within result set 260 to identify at least one more relevant discrete experience indicator. And when ordering 408 the plurality of discrete experience indicators included within each lawyer profile within result set 60, legal research process 10 may promote 410 (e.g., move to the top of the list) the more relevant discrete experience indicator(s) included within each lawyer profile within result set 60, thus generating dynamic result set 66.

Further and as discussed above, legal research process 10 may compare 406 the specific area of the law (i.e., bankruptcy law) to the plurality of discrete experience indicators included within each lawyer profile within result set 60 to identify at least one less relevant discrete experience indicator. And when ordering 408 the plurality of discrete experience indicators included within each lawyer profile within the result set, legal research process 10 may demote 412 (e.g., move to the bottom of the list) the less relevant discrete experience indicator(s) included within each lawyer profile within result set 60, thus generating dynamic result set 66.

Accordingly and continuing with the example defined above, any discrete experience descriptors concerning Chapter 13 bankruptcy may be promoted 410 by legal research process 10 within dynamic result set 66; and any discrete experience descriptors concerning e.g., Chapter 7 bankruptcy may be demoted 412 by legal research process 10 within dynamic result set 66. Therefore, user 38 (when reviewing the attorney profiles included within dynamic result set 66 will see discrete experience descriptors that are prioritized based upon their relevancy with respect to the search criteria (i.e., the filing a Chapter 13 bankruptcy petition). Once generated, legal research process 10 may be configured to provide 414 dynamic result set 66 to (in this example) user 38.

### Comparative Pricing for Defined Tasks:

Legal research process 10 may be configured to allow for an “apples-to-apples” cost comparison concerning identical legal tasks, as opposed to simply comparing attorney billing rates, which often does not provide an indicator of the level of value provided by a particular lawyer.

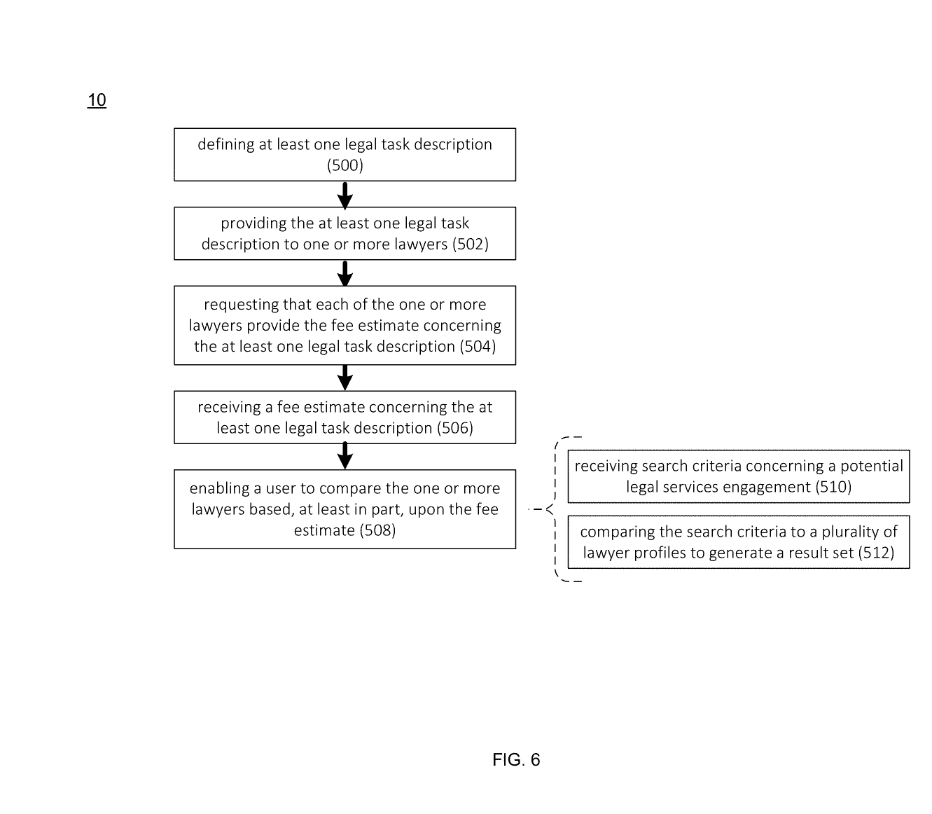

Referring also to FIG. 6 and concerning the Comparative Pricing for Defined Tasks described above, legal research process 10 may be configured to define 500 at least one legal task description. These tasks may be very specific, in that they may definitively define a specific task within a particular area of law so that the lawyer may provide an accurate estimate.

Examples of such a task defined 500 by legal research process 10 may include but are not limited to: the total cost (including legal fees and government fees) for filing a Chapter 13 bankruptcy petition; the total cost (including legal fees and government fees) for filing a Chapter 7 bankruptcy petition; the total cost (including legal fees and government fees) for filing a US trademark application with the USPTO; and the total cost (including legal fees and government fees) for filing a design patent application with the USPTO.

Legal research process 10 may be configured to provide 502 the legal task description(s) to one or more lawyers for a pricing evaluation. Specifically, legal research process 10 may define 500 dozens, hundreds or thousands of these legal task descriptions and legal research process 10 may provide 502 some (or all) of the legal task description(s) to some (or all) of the lawyers for a pricing evaluation. As discussed above, these lawyers may be defined within the lawyer profiles (e.g., lawyer profiles 56) included within the legal database (e.g., database 58). Accordingly, legal research process 10 may be configured to provide 502 all of the legal task description(s) to all of the lawyers defined within legal profiles 56 included within legal database (e.g., database 58) for a pricing evaluation. Alternatively, legal research process 10 may be configured to provide 502 some of the legal task description(s) (e.g., those concerning bankruptcy proceedings) to only some of the lawyers (e.g., only those including bankruptcy experience) defined within legal profiles 56 included within legal database (e.g., database 58) for a pricing evaluation.

Legal research process 10 may be configured to request 504 that each of the lawyers provide the fee estimate concerning the legal task description(s). Upon receiving these legal task description(s), some or all of the lawyers will generate the estimates requested by legal research process 10 and may provide the same to legal research process 10. Legal research process 10 may be configured to receive 506 a fee estimate concerning the legal task description(s) that were provided to the lawyers.

Once received 506, these estimates may be included within/associated with the profile of the attorney who provided the estimate. Accordingly and for the lawyers that provided estimates concerning e.g., the filing of a Chapter 13 bankruptcy petition, legal research process 10 may be configured to enable 508 a user (e.g., user 38) to compare the lawyers based, at least in part, upon the fee estimate that were provided by the lawyers, wherein thus enabling user 38 to make an apples-to-apples price comparison between them.

For example, if Lawyer A (who prepares Chapter 13 bankruptcy petitions) has a billing rate that is double that of Lawyer B (who also prepares Chapter 13 bankruptcy petitions), but Lawyer A (due to experience and/or technology) produces work product three times more quickly than Lawyer B, Lawyer A (with the higher billing rate) would actually provide a higher level of value than Lawyer B (with the lower billing rate). Accordingly, since legal research process 10 provides lawyers identified within their system with one or more particular legal scenarios in their area(s) of expertise and asks these lawyers to provide a price estimate for those procedures, the billing rate is factored out and becomes a non-issue. Accordingly and continuing with the example provided above, user 38 may see that Lawyer A (who has a higher billing rate) can perform a certain service for user 38 for e.g., $5,000 while Lawyer B would charge user 38 $7,500 for performing the same service (despite having a lower billing rate).

When enabling 508 user 38 to compare the lawyers based (at least in part) upon the fee estimate provide by each of the lawyers, legal research process 10 may be configured to receive 510 search criteria concerning a potential legal services engagement for the user (in the fashion discussed above). For example, user 38 may use the above-describe methodology to identify a specific task (e.g., the filing of a Chapter 13 petition) within a particular area of law (e.g., Bankruptcy), thus defining the search criteria (i.e., the filing a Chapter 13 bankruptcy petition).

Further and when enabling 508 user 38 to compare the lawyers based (at least in part) upon the fee estimate provide by each of the lawyers, legal research process 10 may compare 512 the search criteria (i.e., the filing of a Chapter 13 bankruptcy petition) to a plurality of lawyer profiles 56 included within legal database 58 to generate result set 60, wherein each lawyer profile included within result set 60 includes the fee estimate concerning the legal task description(s) (i.e., the filing a Chapter 13 bankruptcy petition). Legal research process 10 may also order the plurality of discrete experience indicators included within each lawyer profile (e.g., lawyer profiles 56 included within legal database 58) within result set 60 in the manner described above.

### Bidirectional Review Verification:

Legal research process 10 may be configured to avoid fraudulent online reviews of an attorney. Specifically and when submitting a review of an attorney, legal research process 10 may require a user to submit an email address and legal research process 10 may inquire as to whether the attorney recognizes the email address (without disclosing the content of the review). If the lawyer confirms the email address, legal research process 10 may post the review. If the lawyer does not recognize the email address, legal research process 10 may ask the user their full name and may present this name to the lawyer. If the lawyer confirms the name, legal research process 10 may post the review. If the lawyer does not recognize the name, legal research process 10 may post the review stating that the review is unverified (thus eliminating the possibility of fraudulent/uncontrolled reviews).

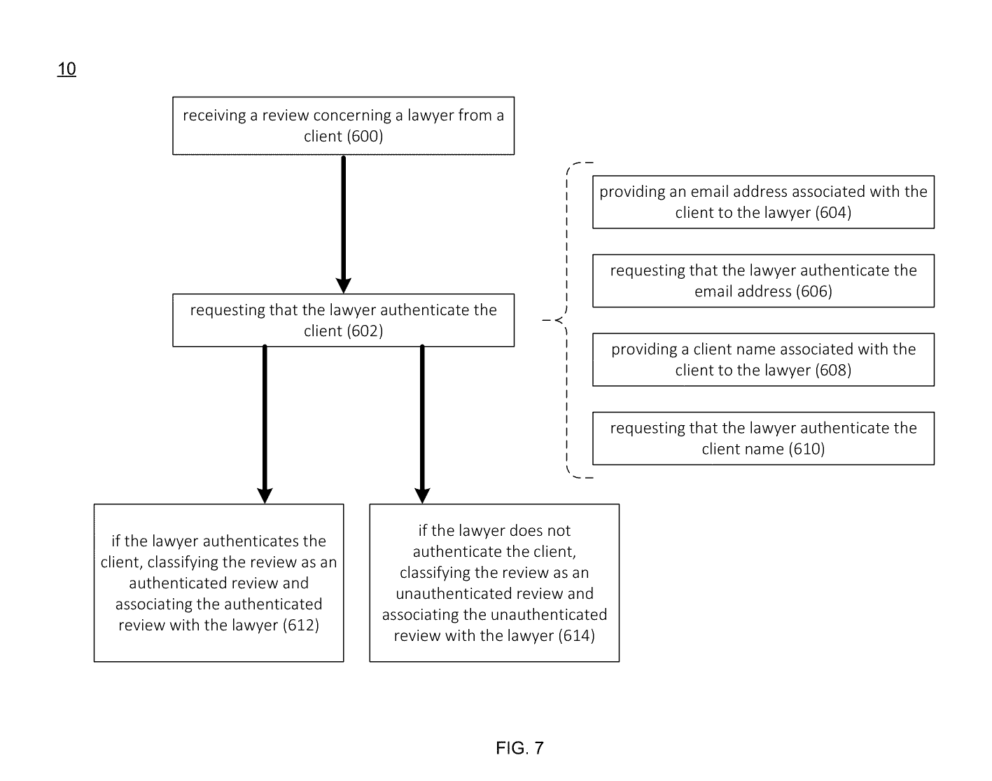

Referring also to FIG. 7 and concerning Bidirectional Review Verification described above, legal research process 10 may be configured to allow users to review lawyers. For example, when a user (e.g., user 38) engages an attorney through legal research process 10, legal research process 10 may allow that user to provide a review (e.g., review 68) of the attorney. Review 68 may be as thorough or as brief as desired (e.g., assigning a score, answering multiple choice questions, or responding to essay questions).

Assume for the following example that user 38 reviews attorney 70 concern e.g., legal services rendered by lawyer 70 for the client (e.g., the handling of the Chapter 13 bankruptcy petition for user 38), thus generating review 68 that is provided to legal research process 10. Upon receiving 600 review 68 concerning lawyer 70 from client 38, legal research process 10 may be configured to request 602 that lawyer 70 authenticate the client. When requesting 602 that lawyer 70 authenticate the client (e.g., user 38), legal research process 10 may provide 604 an email address associated with the client (e.g., user 38) to lawyer 70 (without disclosing the content of the review) and request 606 that lawyer 70 authenticate the email address (e.g., confirm that they have a client with that email address).

If lawyer 70 fails to respond to the request 606 that lawyer 70 authenticate the email address, legal research process 10 may be configured to provide 608 a client name (e.g., John Doe) associated with the client (e.g., user 38) to lawyer 70 and may request 610 that the lawyer authenticate the client name (e.g., confirm that Joe Doe is a client of theirs) without disclosing the content of the review.

If lawyer 70 authenticates the client (either by authenticating the email address of user 38 or the name of user 38), legal research process 10 may be configured to classify 612 review 68 as an authenticated review and may associate the authenticated review with lawyer 70. For example, the authenticated review maybe associated with/included on the attorney profile associated with attorney 70.

If lawyer 70 does not authenticate the client (either by authenticating the email address of user 38 or the name of user 38), legal research process 10 may be configured to classify 614 review 68 as an unauthenticated review and may associate the unauthenticated review with lawyer 70. For example, the unauthenticated review maybe associated with/included on the attorney profile associated with attorney 70.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable legal research processing apparatus, such that the instructions, which execute via the processor of the computer or other programmable legal research processing apparatus, create means for implementing the functions/acts specified in the flowchart and/or block diagram block or blocks.

These computer program instructions may also be stored in a computer-readable memory that may direct a computer or other programmable legal research processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable legal research processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving search criteria concerning a potential legal services engagement for a user;
comparing the search criteria to one or more lawyer profiles to generate a result set, wherein each lawyer profile included within the result set includes a plurality of discrete experience indicators; and
ordering the plurality of discrete experience indicators included within each lawyer profile within the result set based, at least in part, upon the search criteria, thus generating a dynamic result set.

2. The computer-implemented method of claim 1 further comprising:
providing the dynamic result set to the user.

3. The computer-implemented method of claim 1 wherein the search criteria identifies a particular area of the law.

4. The computer-implemented method of claim 3 wherein comparing the search criteria to one or more lawyer profiles to generate a result set includes:
comparing the specific area of the law to the plurality of discrete experience indicators included within each lawyer profile within the result set to identify at least one more relevant discrete experience indicator.

5. The computer-implemented method of claim 4 wherein ordering the plurality of discrete experience indicators included within each lawyer profile within the result set includes:
promoting the at least one more relevant discrete experience indicator when ordering the plurality of discrete experience indicators included within each lawyer profile within the result set.

6. The computer-implemented method of claim 3 wherein comparing the search criteria to one or more lawyer profiles to generate a result set includes:
comparing the specific area of the law to the plurality of discrete experience indicators included within each lawyer profile within the result set to identify at least one less relevant discrete experience indicator.

7. The computer-implemented method of claim 6 wherein ordering the plurality of discrete experience indicators included within each lawyer profile within the result set includes:
demoting the at least one less relevant discrete experience indicator when ordering the plurality of discrete experience indicators included within each lawyer profile within the result set.

8. A computer program product residing on a computer readable medium having a plurality of instructions stored thereon which, when executed by a processor, cause the processor to perform operations comprising:
receiving search criteria concerning a potential legal services engagement for a user;
comparing the search criteria to one or more lawyer profiles to generate a result set, wherein each lawyer profile included within the result set includes a plurality of discrete experience indicators; and
ordering the plurality of discrete experience indicators included within each lawyer profile within the result set based, at least in part, upon the search criteria, thus generating a dynamic result set.

9. The computer program product of claim 8 further comprising instructions for:
providing the dynamic result set to the user.

10. The computer program product of claim 8 wherein the search criteria identifies a particular area of the law.

11. The computer program product of claim 10 wherein comparing the search criteria to one or more lawyer profiles to generate a result set includes:
comparing the specific area of the law to the plurality of discrete experience indicators included within each lawyer profile within the result set to identify at least one more relevant discrete experience indicator.

12. The computer program product of claim 11 wherein ordering the plurality of discrete experience indicators included within each lawyer profile within the result set includes:
promoting the at least one more relevant discrete experience indicator when ordering the plurality of discrete experience indicators included within each lawyer profile within the result set.

13. The computer program product of claim 10 wherein comparing the search criteria to one or more lawyer profiles to generate a result set includes:
comparing the specific area of the law to the plurality of discrete experience indicators included within each lawyer profile within the result set to identify at least one less relevant discrete experience indicator.

14. The computer program product of claim 13 wherein ordering the plurality of discrete experience indicators included within each lawyer profile within the result set includes:
demoting the at least one less relevant discrete experience indicator when ordering the plurality of discrete experience indicators included within each lawyer profile within the result set.

15. A computing system including a processor and memory configured to perform operations comprising:
receiving search criteria concerning a potential legal services engagement for a user;
comparing the search criteria to one or more lawyer profiles to generate a result set, wherein each lawyer profile included within the result set includes a plurality of discrete experience indicators; and
ordering the plurality of discrete experience indicators included within each lawyer profile within the result set based, at least in part, upon the search criteria, thus generating a dynamic result set.

16. The computing system of claim 15 further configured to perform operations comprising:
providing the dynamic result set to the user.

17. The computing system of claim 15 wherein the search criteria identifies a particular area of the law.

18. The computing system of claim 17 wherein comparing the search criteria to one or more lawyer profiles to generate a result set includes:
comparing the specific area of the law to the plurality of discrete experience indicators included within each lawyer profile within the result set to identify at least one more relevant discrete experience indicator.

19. The computing system of claim 18 wherein ordering the plurality of discrete experience indicators included within each lawyer profile within the result set includes:
promoting the at least one more relevant discrete experience indicator when ordering the plurality of discrete experience indicators included within each lawyer profile within the result set.

20. The computing system of claim 17 wherein comparing the search criteria to one or more lawyer profiles to generate a result set includes:
comparing the specific area of the law to the plurality of discrete experience indicators included within each lawyer profile within the result set to identify at least one less relevant discrete experience indicator.

21. The computing system of claim 13 wherein ordering the plurality of discrete experience indicators included within each lawyer profile within the result set includes:
demoting the at least one less relevant discrete experience indicator when ordering the plurality of discrete experience indicators included within each lawyer profile within the result set.
